(19) United States
(12) Patent Application Publication
(10) Pub. No.: US 2014/0212318 A1
(43) Pub. Date: Jul. 31, 2014

(54) METHOD OF PRODUCING A CIRCULAR SAW BLADE HAVING COOLING CHANNELS

(71) Applicant: Arno FRIEDRICHS, Kulmbach (DE)

(72) Inventor: Arno FRIEDRICHS, Kulmbach (DE)

(21) Appl. No.: 14/231,854

(22) Filed: Apr. 1, 2014

Related U.S. Application Data
(62) Division of application No. 12/451,237, filed on Nov. 2, 2009.

(30) Foreign Application Priority Data
May 12, 2007 (DE) 10 2007 022 310.4

(51) Int. Cl. B23D 61/02

(52) U.S. Cl. CPC B23D 61/025
USPC 419/6; 264/610

(57) ABSTRACT

A method is of producing a circular saw blade having cooling channels. In that case, placing of a plurality of thread-shaped bodies on a first circular disc of plastic material is carried out in such a manner that each of the thread-shaped bodies is oriented in radial direction. A second circular disc of plastic material is then placed on the first disc and the thread-shaped bodies. Subsequently, pressure is exerted on the second disc in the direction of the first disc. Removal of the plate-shaped bodies from the compressed disc pair is thereafter carried out, whereby cooling channels are created. Finally, sintering of the disc pair in order to obtain a circular saw blade having cooling channels running in radial direction is carried out.

### CROSS REFERENCE TO RELATED APPLICATIONS

This patent application claims priority under 35 U.S.C. 120 and under 35 U.S.C. 121, and is a divisional patent application of U.S. patent application Ser. No. 12/451,237 filed Nov. 2, 2009, which application is the National Stage of PCT/EP2008/055670 filed on May 8, 2008, which claims priority under 35 U.S.C. §119 of German Application No. 10 2007 022 310.4 filed on May 12, 2007. The international application under PCT article 21(2) was not published in English.

### BACKGROUND OF THE INVENTION

1. Field of the Invention

The invention relates to a method of producing a circular saw blade having cooling channels. Moreover, the invention relates to a circular saw blade having cooling channels.

2. The Prior Art

Circular saw blades having two steel discs extending parallel to one another, between which a cooling medium can be introduced in operation of the circular saw, are already known.

For example, a device for clamping a saw blade is known from Germany Utility Model 80 02 739 U1. The middle part of this saw blade consists of two mutually spaced apart steel cores between which a cavity is formed. A cooling liquid can be introduced into this cavity. For this purpose, the two steel cores are clamped in place between two flanged bodies, of which one is at the same time formed as an inlet channel for the cooling liquid.

A saw blade is known from the further German Utility Model DE 80 02 782 U1, which similarly has two mutually spaced apart steel cores between which a cavity is formed. A cooling liquid can be introduced into this cavity and issues again at the outer circumference of the saw blade. Provided between the steel cores are individual spacers which are, for example, rubber-elastic or plastics-material-elastic spacers. These are firmly connected with the steel cores and in operation of the saw blade contribute to noise attenuation.

A circular saw blade is known from DE 37 08 360 A1, which has a stem blade with cutting elements arranged to be distributed at the outer circumference and a central opening for passage of a drive shaft. The stem blade consists of two mutually parallel discs which are spaced apart by way of spacers and between which flow paths for a coolant with at least one inflow opening as well as outlet openings opening at the outer circumference of the stem blade between the cutting elements are formed. The spacers are formed by elongate spoke elements which are arranged substantially radially as well as distributed over the circumference of the stem blade and between which the flow paths are formed. The spoke elements are integrally connected on their side facing the central opening with an inner disc ring enclosing the central opening. As inflow openings for the coolant at least one of the two discs of the stem blade has, in its region lying radially outside the inner disc ring, passage openings opening into the flow paths. During production of a stem blade of that kind the two discs and the intermediately provided spacer disc have to be connected together, for example by glueing or by spot-welding. The spacer disc itself can be prefabricated by punching out or laser cutting.

### SUMMARY OF THE INVENTION

An object of the invention consists in providing a method of producing a circular saw blade which has cooling channels and by means of which cooling channels of a predetermined cross-section can be produced in simple manner.

This object is achieved by a method with the features of the invention. Advantageous embodiments and developments of the invention are also evident. There are advantageous embodiments and developments of a circular saw blade with the features according to the invention.

The advantages of the invention consist in that by means of the claimed method it is possible to produce unitary circular saw blades having cooling channels. Glueing, welding or screw-connecting of several different solid starting materials is not necessary. Moreover, circular saw blades having cooling channels can be produced from hard metal or ceramic by means of the method according to the invention. The material of these circular saw blades is already hard in such a manner that it is possible to dispense with an additional application of cutting edges, for example of diamond, with these circular saw blades.

Further advantages of the invention consist in that it is possible by means of the claimed method to produce circular saw blades which have cooling channels and in which the cooling channels have the same cross-sectional area over the entire length thereof. This allows a focused introduction of the cooling liquid into the cutting region of the saw blade. The issue points of the cooling liquid are, in advantageous manner, placed in the foot region or middle region of the cutting teeth formed in the circular saw blade.

The circular saw blades produced by means of the method according to the invention can in simple manner be given cooling channels of a desired shape and also cooling channels of a cross-sectional area of desired size. A desired shape of cooling channels, for example a round, oval or polygonal shape of the cooling channels, can be predetermined in that the thread-shaped bodies have a round, oval or polygonal cross-section. After the later removal of these thread-shaped bodies from the compressed disc pair, cooling channels with a round, oval or polygonal cross-sectional area remain in the compressed disc pair. In order to produce cooling channels with a cross-sectional area of a desired size, the cross-sectional area of the employed thread-shaped bodies is selected in desired manner. After the later removal of these thread-shaped bodies from the compressed disc pair cooling channels with the desired cross-sectional area remain in the compressed disc pair.

A further advantage of the invention consists in that by means of the claimed method it is possible to produce circular saw blades which have cooling channels and the cooling channels of which have a very small diameter. This diameter is preferably smaller than or equal to 3 millimetres. This has the advantage that the thickness of the circular saw blade can also be selected to be small overall. Known circular saw blades with integrated cooling channels have, by contrast thereto, a substantially greater thickness.

An advantageous development consists in also providing cooling channels in circumferential direction, by which two or more of the cooling channels running in radial direction are connected together. This has the advantage that in the case of a blockage of a cooling channel arising in operation of the circular saw blade, cooling liquid is nevertheless introduced into the blocked cooling channel by way of a cooling channel running in circumferential direction and can be transported to the desired issue point. In that case the blocked point of the cooling channel is bypassed.

The cross-sectional area of the cooling channels running in circumferential direction is preferably greater than the cross-sectional area of the cooling channels running in radial direction, so that even in the case of unfavourable working conditions all cooling liquid issue points of the circular saw blade can be supplied with sufficient cooling liquid.

In advantageous manner a circular saw blade according to the invention has in its radially inner region, i.e. in the region of the circular saw blade adjoining the central bore, a groove which extends in circumferential direction and by which the cooling channels running in radial direction are connected together. This has the advantage that cooling liquid feed openings of the shaft, which is inserted into the central bore, of the circular saw do not have to run precisely in radial prolongation of the radially extending cooling channels of the circular saw blade. It is quite sufficient if through the cooling liquid outlet openings of the shaft a sufficient quantity of cooling liquid is introduced into the said groove of the circular saw blade.

The afore-described effect is also achieved if the said groove running in circumferential direction is formed not in the circular saw blade, but in the outer circumference of the shaft. An improvement to this effect can be produced in that the circular saw blade and the outer circumference of the shaft are each provided with a respective encircling groove of that kind.

### BRIEF DESCRIPTION OF THE DRAWINGS

The invention is explained by way of example in the following with reference to the figures, in which:

FIGS. 1-8 show sketches for explanation of a method according to the invention,

FIG. 9 shows a sketch of a circular saw blade according to a first exemplifying embodiment for the invention,

FIG. 10 shows a sketch of a circular saw blade according to a second exemplifying embodiment for the invention,

FIG. 11 shows a sketch of a circular saw blade according to a third exemplifying embodiment for the invention,

FIG. 12 shows a sketch of a circular saw blade according to a fourth exemplifying embodiment for the invention and

FIG. 13 shows a sketch of the circular saw blade according to the fourth exemplifying embodiment with teeth formed in the circular saw blade.

### DETAILED DESCRIPTION OF PREFERRED EMBODIMENTS

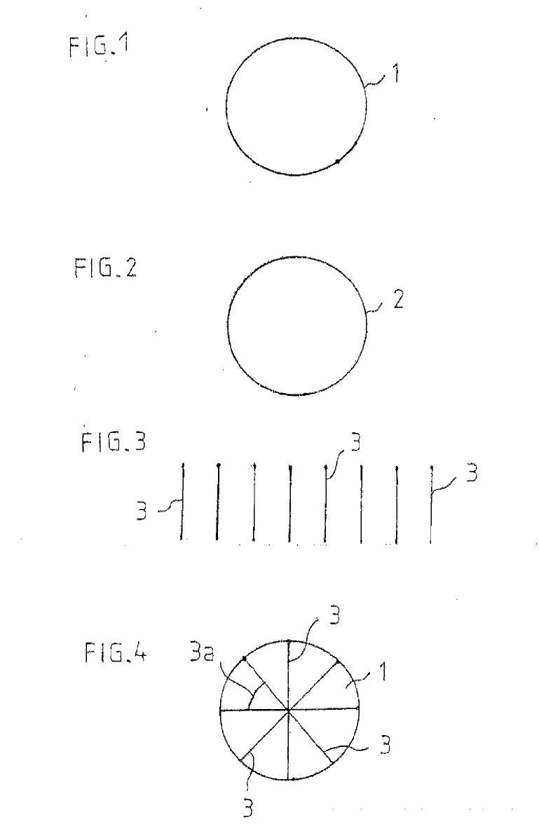

FIGS. 1-8 show sketches for explanation of a method of producing a circular saw blade having cooling channels.

For performance of this method a first circular disc 1, as illustrated in FIG. 1, a second circular disc 2, as shown in FIG. 2, and a plurality of thread-shaped bodies 3, as depicted in FIG. 3, are provided.

The dimensions of the discs 1 and 2 correspond. The discs 1 and 2 consist of one and the same plastic material. This plastic material is a hard metal powder provided with a plasticiser or ceramic powder provided with a plasticiser or steel powder provided with a plasticiser. The consistency of this plastic material is such that the discs can readily deform by exertion of areal pressure.

The thread-shaped bodies 3, the length of which respectively corresponds with the radius of the discs 1 and 2 or is respectively somewhat greater than the radius of the discs 1 and 2, are either bodies of a material which volatilises on application of a high temperature or bodies of a material which liquefies on application of a high temperature. For example, the thread-shaped bodies are paraffin-saturated threads. The cross-sectional area of these thread-shaped bodies 3 is preferably round, but can—insofar as this is desired—also be oval or polygonal. The diameter and the cross-sectional area of all thread-shaped bodies 3 correspond. The diameter is, for example, in the range between 0.05 millimetres and 3 millimetres.

In a first step the thread-shaped bodies 3 are placed on the first circular disc 1 in such a manner that each of the thread-shaped bodies is oriented in radial direction. This is illustrated in FIG. 4, from which it is apparent that the thread-shaped bodies 3 after placing on the disc 1 form, in their entirety, a star, of which the centre point is the centre point of the disc 1 and the rays of which extend out from the centre point in direction up to the outer edge of the disc or—if the thread-shaped bodies are longer than the radius of the disc 1—project beyond the outer edge of the disc 1.

In a succeeding step the second circular disc 2 is placed on the first circular disc 1 and the thread-shaped bodies 3 resting thereon. This is illustrated in FIG. 5, which shows a schematic side view of the discs 1 and 2 and the intermediately positioned thread-shaped bodies 3.

In the next step of the method, pressure P, which is oriented in the direction of the first disc 1, is exerted on the second disc 2. This is illustrated in FIG. 6, from which it is apparent that after exertion of the pressure P the two discs 1 and 2 form a compressed disc pair, which discs are in direct contact at all points at which no thread-shaped bodies 3 are positioned and are spaced from one another by thread-shaped bodies 3 at the points at which these thread-shaped bodies 3 are positioned. The cross-sectional area of each of the thread-shaped bodies 3 has not changed during the said exertion of pressure P. This means that the thread-shaped bodies 3 serve as locators during the compressing of the discs 1 and 2.

In the step of the method following thereon the thread-shaped bodies 3 are removed from the compressed disc pair 1, 2.

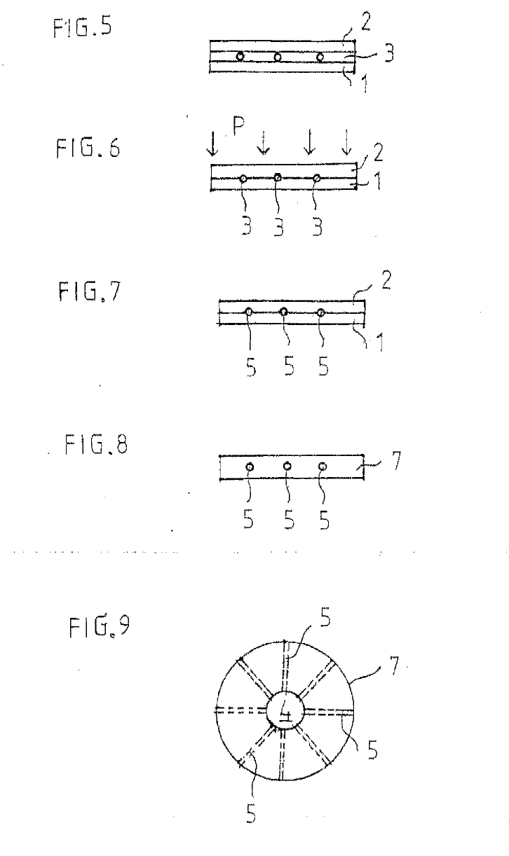

If the thread-shaped bodies 3 are bodies consisting of a material which volatiles on application of a high temperature, then for removal of the thread-shaped bodies 3 the disc pair is exposed to the said high temperature, which lies at, for example, 200° C. This has the consequence that the thread-shaped bodies 3 vaporise so that continuous cooling channels 5, the cross-sectional area of which corresponds with the cross-sectional area of the thread-shaped bodies 3, are created in the compressed disc air. This is illustrated in FIG. 7, from which it is apparent that after volatilisation of the thread-shaped bodies 3 cooling channels 5 with round cross-sectional area remain in the compressed disc pair 1, 2.

If, thereagainst, the thread-shaped bodies 3 are bodies consisting of a material which liquefies on application of a high temperature, then for removal of the thread-shaped bodies 3 the disc pair is exposed to the said high temperature. This has the consequence that the thread-shaped bodies 3 liquefy. This formed liquid flows outwardly out of the compressed discs so that continuous cooling channels 5, the cross-sectional area of which corresponds with the cross-sectional area of the thread-shaped bodies 3, remain in the compressed disc pair. This is illustrated in FIG. 7, from which it is apparent that, after the liquefying of the thread shaped bodies, cooling channels 5 with round cross-sectional area remain in the compressed disc pair 1, 2.

According to a further form of embodiment of the invention the thread-shaped bodies can also consist of a solid material and removal of the thread-shaped bodies from the compressed disc pair can be carried out by pulling, which is carried out outwardly in radial direction, of the thread-shaped bodies 3 from the compressed disc pair. In this further form of embodiment the length of the thread-shaped bodies 3 is so selected that it is greater than the radius of the discs 1 and 2 so as to make it possible to grip the thread-shaped bodies for the purpose of withdrawal thereof. In this form of embodiment it is necessary to ensure that on withdrawal of the thread-shaped bodies 3 from the disc pair 1, 2 there is no deformation of the formed cooling channels.

In the next method step sintering of the disc pair 1, 2 is carried out in order to obtain a circular saw blade 7 having cooling channels 5 running in radial direction. This is illustrated in FIG. 8, from which it is also apparent that the circular saw blade 7 having cooling channels 5 is a unitary circular saw blade consisting of a single material. This material is a hard metal, ceramic or steel. In addition, all portions of the blade are sintered.

Since a circular saw blade has to be fastened to a shaft of the circular saw the need exists to form a central bore 4 in the disc pair 1, 2, as is shown in, for example, FIG. 9. This forming of the central bore 4 in the disc pair 1, 2 is carried out either before or after sintering of the disc pair by means of a suitable tool, for example a suitable drilling or turning tool.

Moreover, a circular saw blade usually has teeth along its outer circumference, as is illustrated by way of example in FIG. 13. The forming of these teeth in the disc pair can be similarly undertaken either before or after sintering of the disc pair by means of a suitable tool, for example by means of suitable grinding wheels.

An advantageous development of a method according to the invention consists in placing on the first disc 1, additionally to the thread-shaped bodies 3 illustrated in FIG. 4 and oriented in radial direction, also further thread-shaped bodies 3a oriented in circumferential direction. A further thread-shaped body 3a of that kind is illustrated in FIG. 4. As a result, after removal of all thread-shaped bodies from the compressed disc pair there are created not only cooling channels oriented in radial direction, but also cooling channels which run in circumferential direction and by which the cooling channels running in radial direction are connected together. This has the advantage that in the case of a blockage of one of the cooling channels running in radial direction a cooling liquid exchange between adjacent cooling channels running in radial direction can take place, so that notwithstanding the said blockage of a cooling channel the necessary amount of cooling liquid can get to all desired cooling liquid issue points of the circular saw blade.

The cooling channels running in circumferential direction preferably have a greater cross-sectional area than the cooling channels running in radial direction so as to also be able to supply a greater number of cooling channels with coolant even in unfavourable space conditions with a smaller number of cooling channels in the centre.

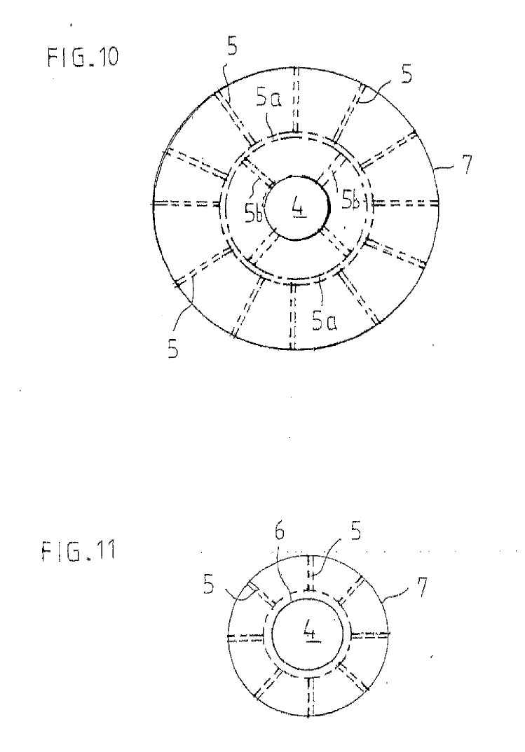

Another advantageous development consists in providing the circular saw blade in its radially inner region, which adjoins the central bore 4, with a groove 6 which extends in circumferential direction and by which the radially running cooling channels 5 are connected together. A groove 6 of that kind is illustrated by way of example in FIG. 11. This has the advantage that cooling liquid openings of the shaft, which is inserted into the central bore 4, of the circular saw do not have to run precisely in radial prolongation of the radially extending cooling channels of the circular saw blade. It is quite sufficient if a sufficient quantity of cooling liquid is introduced into the said groove 6 of the circular saw blade by the cooling liquid outlet openings of the shaft.

FIG. 9 shows a sketch of a circular saw blade 7 according to a first exemplifying embodiment for the invention. This circular saw blade 7 has cooling channels 5 which run in radial direction and are shown in dashed lines and which each extend from the central bore 4 up to the outer circumference of the circular saw blade 7. The cooling channels 5 each have one and the same cross-sectional area over the entire length thereof.

FIG. 10 shows a sketch of a circular saw blade 7 according to a second exemplifying embodiment for the invention. This circular saw blade has cooling channels 5 which run in radial direction and are shown in dashed lines, cooling channels 5a which run in circumferential direction and which are similarly shown in dashed lines, and cooling channels 5b which run in radial direction and extend from the central bore 4 up to the cooling channels 5a running in circumferential direction. The cooling channels 5 running in radial direction and also the cooling channels 5a are connected together by the cooling channels 5a. The cooling channels 5 each have one and the same cross-sectional area over the entire length thereof. The cooling channels 5a similarly have one and the same cross-sectional area over the entire length thereof. The cross-sectional area of the cooling channels 5a can correspond with the cross-sectional area of the cooling channels 5 or be greater than this. The cooling channels 5b also have one and the same cross-sectional area over the entire length thereof. This can be greater than the cross-sectional area of the cooling channels 5 and also be greater than the cross-sectional area of the cooling channels 5a.

FIG. 11 shows a sketch of a circular saw blade according to a third exemplifying embodiment for the invention. This circular saw blade 7 has cooling channels 5 which run in radial direction and are shown in dashed lines and which extend from a groove 6 up to the outer circumference of the circular saw blade 7. The cooling channels 5 each have one and the same cross-sectional area over the entire length thereof. The groove 6 is adjacent to the central bore 4 of the circular saw blade, runs in circumferential direction and connects the cooling channels 5 together.

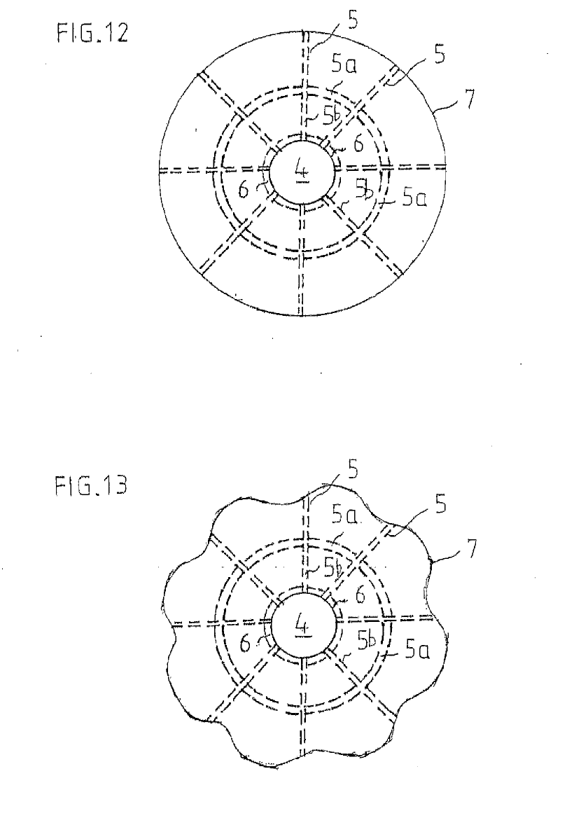

FIG. 12 shows a sketch of a circular saw blade according to a fourth exemplifying embodiment for the invention. This circular saw blade 7 has cooling channels 5 and 5b which run in radial direction and are shown in dashed lines as well as cooling channels 5a which run in circumferential direction and are similarly shown in dashed lines. The cooling channels 5 and 5b running in radial direction are connected together by the cooling channels 5a. The cooling channels 5 each have one and the same cross-sectional area over the entire length thereof. The cooling channels 5a similarly have one and the same cross-sectional area over the entire length thereof. The cross-sectional area of the cooling channels 5a can correspond with the cross-sectional area of the cooling channels 5 or be greater than this. In addition, the cooling channels 5b have one and the same cross-sectional area over the entire length thereof. This can be greater than the cross-sectional area of the cooling channels 5 and also be greater than the cross-sectional area of the cooling channels 5a. In addition, the circular saw blade has a groove 6 which extends in circumferential direction and which is adjacent to the central bore 4 of the circular saw blade 7 and connects the cooling channels 5 together.

FIG. 13 shows a sketch of the circular saw blade 7 according to the fourth exemplifying embodiment for the invention with teeth formed in the circular saw blade. It will be evident that the teeth are formed in the outer circumference of the circular saw blade in such a manner that the outlet openings of the cooling channels 5 lie in the region of the flank centres of the teeth.

### REFERENCE NUMERAL LIST

1 first circular disc

2 second circular disc

3 thread-shaped body

3a further thread-shaped body

4 central bore

5, 5b cooling channel running in radial direction

5a cooling channel running in circumferential direction

6 groove

7 circular saw blade

P pressure

What is claimed is:

1. Method of producing a circular saw blade having cooling channels, comprising the following steps:
placing a plurality of thread-shaped bodies (3) on a first circular disc (1) of plastic material in such a manner that each of the thread-shaped bodies is oriented in radial direction,
placing a second circular disc (2) of plastic material on the first disc and the thread-shaped bodies,
exertion of pressure (P) on the second disc in the direction of the first disc for formation of the compressed disc pair,
removal of the thread-shaped bodies (3) from the compressed disc pair and
sintering of the disc pair to obtain a circular saw blade having cooling channels (5) running in radial direction.

2. Method according to claim 1, wherein the plastic material is hard metal powder provided with a plasticiser, ceramic powder provided with a plasticiser or steel powder provided with plasticiser.

3. Method according to claim 1, wherein the thread-shaped bodies (3) consist of a material which volatilises on application of a high temperature and that the removal of the thread-shaped bodies from the compressed disc pair is carried out by application of the high temperature.

4. Method according to claim 1, wherein the thread-shaped bodies (3) consist of a material which liquefies on application of a high temperature and that the removal of the thread-shaped bodies from the compressed disc pair is carried out by application of the high temperature.

5. Method according to claim 1, wherein the removal of the thread-shaped bodies (3) from the compressed disc pair is carried out by pulling the thread-shaped bodies out of the compressed disc pair.

6. Method according to claim 1, wherein a central bore (4) is formed in the disc pair (1, 2) before or after sintering of the disc pair.

7. Method according to claim 1, wherein teeth are formed in the disc pair (1, 2) at the outer circumference thereof before or after sintering of the disc pair (1, 2).

8. Method according to claim 1, wherein further thread-shaped bodies (3a) are placed on the first disc (1) in such a manner that each of these thread-shaped bodies is oriented in circumferential direction of the first disc.

9. Method according to claim 1, wherein the circular saw blade with cooling channels (5) running in radial direction, is of unitary construction and consists of a single material of hard metal, steel or ceramic and all portions of the blade are sintered.

10. The method according to claim 9, wherein the cooling channels (5) respectively of the circular saw blade have the same cross-sectional area over the entire length of thereof.

11. The method according to claim 9, wherein the cooling channels each have a circular cross-sectional area.

12. The method according to claim 9, wherein the cooling channels each have an oval cross-sectional area.

13. The method according to claim 9, wherein the cooling channels each have an polygonal cross-sectional area.

14. The method according to claim 9, wherein one, several or all of its cooling channels has or have a diameter for which D≦3 mm applies.

15. The method according to claim 9, wherein it has one or more cooling channels (5a) which run in circumferential direction and by which radially extending cooling channels (5) are connected together.

16. The method according to claim 9, wherein it has cooling channels (5b) which run in radial direction and extend from a central bore (4) to the cooling channels (5a) running in circumferential direction and the cross-sectional area of which is greater than the cross-sectional area of the cooling channels (5a) running in circumferential direction and/or greater than the cross-sectional area of further cooling channels (5) which run in radial direction and extend from the cooling channels (5a)—which run in circumferential direction—to the outer edge of the circular saw blade.

17. The method according to claim 9, wherein the cross-sectional area of the cooling channels (5a) running in circumferential direction is greater than the cross-sectional area of the cooling channels (5) running in radial direction.

18. The method according to claim 9, wherein it is provided in its radially inner region with a groove (6) which runs circumferential direction and by which radially extending cooling channels are connected together.

19. The method according to claim 1,
wherein a thread-shaped body (3) is contained in each cooling channel (5) before sintering; and
each cooling channel (5) is free from said thread-shaped body (3) after sintering.

20. The method according to claim 19,
wherein each thread-shaped body (3) consists of a material which volatilises on application of a high temperature.

21. The method according to claim 19,
wherein each thread-shaped body (3) consist of a material which liquefies on application of a high temperature.
